(19) United States
(12) Patent Application Publication
(10) Pub. No.: US 2017/0066160 A1
(43) Pub. Date: Mar. 9, 2017

(54) METHOD OF PRODUCING SYNTHETIC RESIN STAMP

(71) Applicant: Taiyotomah Co., Ltd., Osaka (JP)

(72) Inventors: Ikuzo MATSUSHITA, Osaka (JP); Yoshiaki NAGATA, Osaka (JP)

(21) Appl. No.: 15/255,471

(22) Filed: Sep. 2, 2016

(30) Foreign Application Priority Data
Sep. 7, 2015 (JP) 2015-175553

(51) Int. Cl. B29C 33/38

(52) U.S. Cl. CPC B29C 33/3842; B29K 2023/06; B29L 2031/757

(57) ABSTRACT

A method of producing a synthetic resin stamp includes the steps of mixing 35 to 45 weight % of a polyethylene resin, 11 to 22 weight % of a thermoplastic elastomer, 35 to 45 weight % of a filling material, 2 to 7 weight % of a cross-linking agent, and 2 to 7 weight % of a foaming agent to obtain a molding material; placing the molding material in a molding die; performing a direct pressure molding at 160° C. to 190° C. for 3 to 10 minutes for performing a cross-linking reaction and a foaming reaction to obtain a foamed molded member formed of foam cells; slicing the foamed molded member to obtain a sliced member; and performing a laser engraving process on a surface of the sliced member to obtain the synthetic resin stamp.

### BACKGROUND OF THE INVENTION AND RELATED ART STATEMENT

The present invention relates to a method of producing a synthetic resin stamp having a seal face formed through a laser engraving process.

Patent Reference has disclosed a conventional synthetic resin stamp. According to Patent Reference, the conventional synthetic resin stamp is formed of a base rubber containing calcium carbonate as a rubber raw material thereof.

Patent Reference: Japanese Patent Publication No. 11-42842

In the conventional synthetic resin stamp using the rubber raw material, when a seal face is produced through a laser engraving process, strong odor tends to generate. Further, a burnt residue of the rubber raw material tends to stick to the seal face after the seal face is produced through the laser engraving process. Accordingly, it is necessary to perform an additional step to remove the burnt residue of the rubber raw material.

In view of the problems described above, an object of the present invention is to provide a method of producing a synthetic resin stamp capable of solving the problems of the conventional synthetic resin stamp. In the present invention, it is possible to produce a seal face of the synthetic resin stamp through a laser engraving process without generating strong odor. Further, it is possible to produce the seal face of the synthetic resin stamp through a simple cleaning step.

Further objects of the invention will be apparent from the following description of the invention.

### SUMMARY OF THE INVENTION

In order to attain the object described above, according to the present invention, a method of producing a synthetic resin stamp includes the step of mixing 35 to 45 weight % of a polyethylene resin, 11 to 22 weight % of a thermoplastic elastomer, 35 to 45 weight % of a filling material, 2 to 7 weight % of a cross-linking agent, and 2 to 7 weight % of a foaming agent to obtain a molding material; placing the molding material in a molding die; performing a direct pressure molding at 160° C. to 190° C. for 3 to 10 minutes for performing a cross-linking reaction and a foaming reaction to obtain a foamed molded member formed of foam cells; slicing the foamed molded member to obtain a sliced member; and performing a laser engraving process on a surface of the sliced member to obtain the synthetic resin stamp.

In the present invention, the molding material does not contain a vulcanization agent (sulfur) or a vulcanization promoting agent (a nitride compound). Accordingly, when the laser engraving process is performed on the seal surface of the synthetic resin stamp, it is possible to prevent a strong odor from being generated. In other words, it is possible to prevent an environmental hazardous material such as sulfur oxide or nitride oxide from being generated. Further, after the seal face is produced through the laser engraving process, it is possible to easily remove a burnt residue that sticks to the seal surface simply through washing with water or brushing. Accordingly, it is possible to significantly improve the cleaning step.

### BRIEF DESCRIPTION OF THE DRAWINGS

FIG. 1 is a process chart showing a method of producing a synthetic resin stamp according to an embodiment of the present invention;

FIG. 2 is a schematic perspective view showing a foamed molded member obtained through a cross-linking and foaming molding process according to the embodiment of the present invention; and

FIG. 3 is a schematic perspective view showing a sliced member obtained through a slicing process on which a laser engraving process is performed according to the embodiment of the present invention.

### DETAILED DESCRIPTION OF PREFERRED EMBODIMENTS

Hereunder, embodiments of the present invention will be hereinafter described with reference to the drawing.

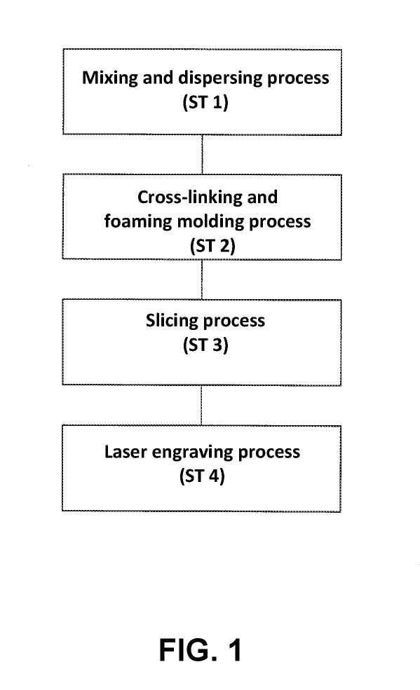

A method of producing a synthetic resin stamp will be explained with reference to FIG. 1. FIG. 1 is a process chart showing the method of producing the synthetic resin stamp according to an embodiment of the present invention. In the embodiment, a seal face of the synthetic resin stamp is formed through a laser engraving process.

As shown in FIG. 1, the method of producing the synthetic resin stamp includes a mixing and dispersing process ST1, a cross-linking and foaming molding process ST2, a slicing process ST3, and a laser engraving process ST4.

In the embodiment, in the mixing and dispersing process ST1, a polyethylene resin, a thermoplastic elastomer, a filling material, and a foaming agent are mixed together to obtain a molding material. If necessary, an additional additive may be added. In the cross-linking and forming molding process ST2, the molding material is placed or injected into a molding die. Then, a direct pressure molding is performed at 160° C. to 190° C. for 3 to 10 minutes, so that a cross-linking reaction and a foaming reaction are progressed to obtain a foamed molded member.

In the embodiment, in the slicing process ST3, the foamed molded member thus obtained is sliced to obtain a sliced member. In the laser engraving process ST4, a laser engraving process is performed on a surface of the sliced member to obtain the synthetic resin stamp.

In the embodiment, the polyethylene resin and the thermoplastic elastomer are preferably crossing-linking type polymers capable of cross-linking with the cross-linking agent (described later). It should be noted that the polyethylene resin used in the embodiment is not limited to a specific one, and preferably includes a metallocene plastomer such as an ethylene-α-olefin copolymer that is synthesized with a metallocene catalyst. Further, it should be noted that the thermoplastic elastomer used in the embodiment is not limited to a specific one, and preferably includes a thermoplastic elastomer of a hydrogenated styrene type. Further, it should be noted that the filing agent used in the embodiment may preferably includes an inorganic compound, especially, talc.

In the embodiment, the cross-linking agent is capable of cross-linking the polyethylene resin and the thermoplastic elastomer to be used. The cross-linking agent capable of cross-linking the polyethylene resin and the thermoplastic elastomer includes a dialkylperoxide type cross-linking agent, a peroxy ketal type cross-linking agent, a hydroperoxide type cross-linking agent, a peroxy ester type cross-linking agent, a dialkyl peroxide type, and the like. The cross-linking agent preferably has a high decomposition temperature, so that the cross-linking agent can be heated approximately to 90° C. to 120° C. in a process of kneading the molding material.

When the cross-linking agent has an excessively high decomposition temperature, it is necessary to increase the cross-linking temperature. On the other hand, when the cross-linking agent has an excessively low decomposition temperature, the cross-linking agent may start to decompose during the process of kneading, thereby making it difficult to obtain a good molded material. Therefore, it is preferred that the maximum kneading temperature is 100° C. or less and the cross-linking agent has a standard cross-linking temperature approximately of 160° C. to 180° C. Accordingly, the cross-linking agent is preferably selected from dialkylperoxides.

In the embodiment, the foaming agent used in the embodiment is not limited to a specific one, and preferably includes an organic thermal decomposition type foaming agent.

The organic thermal decomposition type foaming agent includes an azo type foaming agent, especially azo-dicarbonyl-amide having a decomposition temperature of about 150° C.

In the embodiment, in addition to the polyethylene resin, the thermoplatic elastomer, the filling material, the foaming agent, and the cross-linking agent, the molding material may contain various additives such as a dispersion agent, a plasticizing agent, mineral oil, a surface activating agent, a pigment, a thermal stabilizer, a lubricant, an ultraviolet absorbing agent, an antistatic agent, a fire retarding material, and an anti-aging agent. It is preferred that the additive is added 10 parts by weight or less with respect to 100 parts by weight of the molding material.

In the embodiment, in the mixing and dispersing process ST1, the polyethylene resin, the thermoplastic elastomer, the filling material, the cross-linking agent, and the foaming agent are mixed preferably at the following weight part ratios to obtain the molding material; 35 to 45 weight % of the polyethylene resin, 11 to 22 weight % of the thermoplastic elastomer, 35 to 45 weight % of the filling material, 2 to 7 weight % of the cross-linking agent, and 2 to 7 weight % of the foaming agent.

In the embodiment, the weight part ratio of the cross-linking agent may be determined according to the weight part ratios of the polyethylene resin and the thermoplastic elastomer. It should be noted that the weight part ratio of the foaming agent tends to have an influence on ink permeability (so called, ink compatibility) on the seal surface. When the weight part ratio of the foaming agent is less than 2 weight %, the ink compatibility tends to be deteriorated. On the other hand, when the weight part ratio of the foaming agent is less than 2 weight %, the foam cells tends to occupy an excessive extent relative to the seal surface, thereby deteriorating engrave fineness of the seal surface.

As described above, in the embodiment, the molding material contains 35 to 45 weight % of the filling material.

The total weight part of the polyethylene resin and the thermoplastic elastomer as a main component of the synthetic resin stamp is between 46 weight % and 67 weight %. Accordingly, the molding material contains at least 57% and at most 98% of the filling material relative to the main component of the polyethylene resin and the thermoplastic elastomer.

More specifically, the molding material contains at least 57% of the filling material when the total weight part of the polyethylene resin and the thermoplastic elastomer is 61 weight %, the weight part of the filling material is 35 weight %, and the total weight part of the cross-linking agent and the foaming agent is 4 weight % (35 divided by 61 equals to 0.57). Further, the molding material contains at most 98% of the filling material when the total weight part of the polyethylene resin and the thermoplastic elastomer is 46 weight %, the weight part of the filling material is 45 weight %, and the total weight part of the cross-linking agent and the foaming agent is 9 weight % (45 divided by 46 equals to 0.98). When the molding material contains at least 57% and at most 98% of the filling material relative to the main component, it is possible to reduce an amount of the burnt residue upon the laser engraving and prevent the burnt residue from sticking to the seal surface too strongly. As a result, it is possible to easily remove the burnt residue only with water washing or brushing.

As described above, in the embodiment, in the mixing and dispersing process ST1, the polyethylene resin, the thermoplastic elastomer, the filling material, the cross-linking agent, and the foaming agent are mixed uniformly to obtain the molding material. If necessary an additional additive may be mixed together. In the mixing and dispersing process ST1, an open roll mill, a heat/pressure kneader, an intensive mixer, a single screw extruder, a twin screw extruder, an internal mixer, a co-kneader, or a continuous kneading machine with a twin screw rotor may be arbitrarily used.

In the cross-linking and foaming molding process ST2 according to the embodiment, the molding material obtained in the mixing and dispersing process ST1 is filled in a molding die having a cavity corresponding to a shape of the molded member. Then, a direct pressure molding (referred to as a compression molding or a heat press molding) is performed under a specific condition (described later), so that a cross-linking reaction and a foaming reaction are performed coincidentally.

In the embodiment, a temperature for the cross-linking reaction and the foaming reaction is in a range from 150° C. to 190° C., at which the thermoplastic resin such as the polyethylene resin and the thermoplastic elastomer melts thereby to soften, the cross-linking agent decomposes to produce a cross-linked material, and the foaming agent starts foaming. A period of time for the cross-linking reaction and the foaming reaction is in a range from three to 10 minutes with the inclusion of preheating, air evacuating and gas evacuating.

In the embodiment, when the temperature for the cross-linking reaction exceeds 190° C., the cross-linking reaction progresses too fast. In this case, the cross-linking reaction excessively progresses in the preheating stage, thereby making it difficult to obtain a high-quality molded material. On the contrary, when the temperature for the cross-linking reaction is lower than 150° C., the cross-linking reaction may not sufficiently complete. In this case, a void or a cavity may be generated in the molded material, or it may be difficult to remove a portion of the molded material from the molding die, thereby making it difficult to obtain a high-quality molded material. When the time duration for the cross-linking reaction is shorter than three minutes, the cross-linking reaction may not complete, thereby making it difficult to obtain a high-quality molded material. On the other hand, when the time duration for the cross-linking reaction exceeds ten minutes, the productivity becomes lower, thereby increasing a cost of the product.

In the cross-linking and foaming molding process ST2, the molding die includes a metal molding die made of aluminum, iron or the like, or a synthetic resin molding die made of phenol resin, ebonite or the like. When the metal molding die is made of copper or an alloy thereof such as brass, copper tends to inhibit the cross-linking reaction, so that the metal molding die may not be suitable.

In the cross-linking and foaming molding process ST2, a direct pressure molding machine includes a heat press machine to be usually used for cross-linking a rubber, and a pressing capability thereof may be approximately within a range from 10 to 50 tons. While it is enough to heat up to approximately 200° C., an accurate temperature control is required.

In the cross-linking and foaming molding process ST2, after pre-heating the molding die to be used to a molding temperature, the molding material in a pellet-form is uniformly filled in the molding die. Then, the molding material is molded to obtain the foamed molded material under the pressing and heating condition for three to 10 minutes through pre-heating, pressing, air evacuating and gas evacuating in this order. It should be noted that the foamed molded material is removed from the molding die after being naturally cooled down for 30 to 60 seconds. Accordingly, it is possible to stabilize a shape of the foamed molded material.

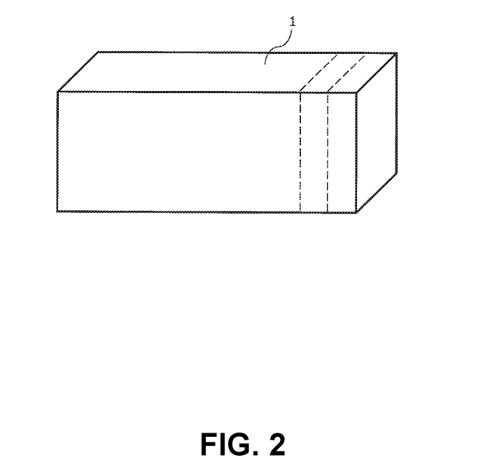

FIG. 2 is a schematic perspective view showing the foamed molded member 1 obtained through the cross-linking and foaming molding process ST2 according to the embodiment of the present invention.

As shown in FIG. 2, the foamed molded material 1 has a cuboid shape. It should be noted that the shape of the foamed molded material 1 is not limited to the cuboid shape, and the foamed molded material 1 may be formed in an arbitrary shape according to a shape of a final product (a stamp). For example, when it is intended to produce a stamp having a round shape, the foamed molded material 1 may be formed in a cylindrical shape.

In the embodiment, in the slicing process ST3, the foamed molded material 1 is sliced along broken lines shown in FIG. 2. More specifically, in the embodiment, the foamed molded material 1 is not processed in an original shape to produce the stamp. Rather, the foamed molded material 1 is sliced, so that a sliced surface of the foamed molded material 1 is processed as a seal surface of the stamp. It should be noted that the foamed molded material 1 is sliced along the broken lines in the embodiment. Alternatively, the foamed molded material 1 may be sliced according to the shape of the final product (the stamp).

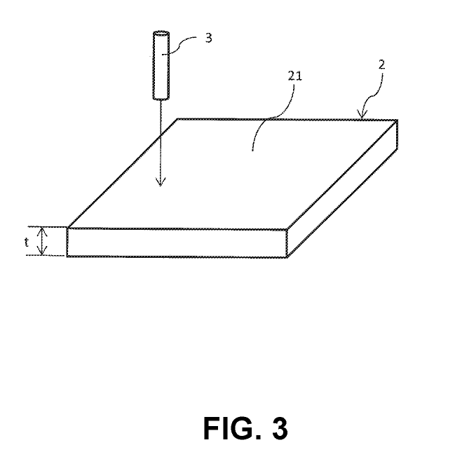

FIG. 3 is a schematic perspective view showing a sliced member obtained through the slicing process ST3 on which a laser engraving process is performed according to the embodiment of the present invention.

As shown in FIG. 3, when the foamed molded material 1 is sliced along the broken lines with a specific thickness t, the sliced member has a sliced surface 21. It should be noted that the sliced member has the sliced surface 21 on the opposite side depending on a location of the sliced member in the formed molded material 1. The sliced surface 21 is processed with the laser engraving process, so that the sliced member becomes the stamp 2.

In the embodiment, @01 obtained through the cross-linking and foaming molding process ST2 contains as the main components 15 weight % to 40 weight % of the polyethylene resin, 14 weight % to 40 weight % of the thermoplastic elastomer, and 38 to 45 weight % of the filling material. Then, the foamed molded material 1 is sliced through the sliced member obtained through the slicing process ST3, so that the sliced surface 21 is a foamed surface formed of the foam cells.

In the embodiment, as shown in FIG. 3, in the laser engraving process ST4, a laser radiation device 3 is moved along the sliced surface 21 as the foamed surface in a two dimensional space or a three dimensional space, so that a desired text or a desired pattern is engraved in the sliced surface 21.

In the embodiment, the foamed molded material 1 does not contain a vulcanization agent (sulfur) or a vulcanization promoting agent (a nitride compound), which might cause strong smell. Instead, the foamed molded material 1 is formed of the polyethylene resin and the thermoplastic elastomer containing at least 57% and at most 98% of the filling material formed of the inorganic compound such as talc. Accordingly, only a small amount of material is combustible. As a result, in the laser engraving process ST4, when the sliced surface 21 is engraved with the laser radiation device 3 to obtain the stamp 2, it is possible to prevent burning smell.

Further, in the embodiment, the foamed molded material 1 contains at least 57% and at most 98% of the filling material formed of the inorganic compound such as talc relative to the polyethylene resin and the thermoplastic elastomer. Accordingly, when the sliced surface 21 is engraved with the laser radiation device 3 to obtain the stamp 2, it is possible to produce only a small amount of the burnt residue, and to prevent the burnt residue from sticking to the seal surface or easily remove the burnt residue with water washing or brushing.

In the embodiment, when the stamp 2 is used, the seal surface 21 where a text or a pattern is engraved is pushed against a stamp pad (an ink pad), so that ink attached to the seal surface 21 is stamped on an object to be stamped. As described above, the seal surface 21 of the stamp 2 has the foamed surface formed of a large number of the foam cells. Accordingly, ink tends to easily enter the foam cell having a fine undulated structure, thereby making it possible to obtain the fine stamped seal text or pattern with high quality.

In the embodiment, it should be noted that the polyethylene resin is the main component of the stamp 2. Accordingly, it is possible to achieve good solvent resistance against a quick dry solvent type ink. Also, it is possible to prevent the seal surface 21 from dissolving.

### EXAMPLE NO. 1

An example No. 1 of the embodiment of the present invention will be explained next. In the example No. 1, 70 parts of the thermoplastic elastomer, 30 parts of an ultra low-density polyethylene, 70 parts of the filling material (talc), 4 parts of the cross-linking agent, and 4 parts of the foaming agent are uniformly mixed to obtain a uniform mixture. Then, the uniform mixture is processed and kneaded with a twin screw extruder to obtain the molding material (the example No. 1).

### EXAMPLE NO. 2

An example No. 2 of the embodiment of the present invention will be explained next. In the example No. 2, 30 parts of the thermoplastic elastomer, 70 parts of an ultra low-density polyethylene, 70 parts of the filling material (talc), 4 parts of the cross-linking agent, and 4 parts of the foaming agent are uniformly mixed to obtain a uniform mixture. Then, similar to the example No. 1, the uniform mixture is processed and kneaded with the twin screw extruder to obtain the molding material (the example No. 2).

### EXAMPLE NO. 3

An example No. 3 of the embodiment of the present invention will be explained next. In the example No. 3, 50 parts of ethylene vinyl acetate co-polymer (a vinyl acetate content is 20%), 70 parts of an ultra low-density polyethylene, 70 parts of the filling material (talc), 4 parts of the cross-linking agent, and 4 parts of the foaming agent are uniformly mixed to obtain a uniform mixture. Then, similar to the example No. 1, the uniform mixture is processed and kneaded with the twin screw extruder to obtain the molding material (the example No. 3).

An experiment was conducted to evaluate the example No. 1 to the example No. 3 obtained through the process described above.

In the experiment, 340 g of the molding materials of the examples No. 1 to No. 3 were placed in a metal frame having a thickness of 7.5 mm and an inner volume of 274 cm³. Then, the metal frame was heated at 190° C. for five minutes, so that the molding materials of the examples No. 1 to No. 3 were cross-linked and foamed. As a result, the foamed molded member having a foaming ratio of 2.9 to 3.5 times and a thickness of 13.5 mm was obtained.

In the next step, an upper surface and a lower surface of the foamed molded member were sliced and removed by 1 mm, respectively. Accordingly, the foamed molded member had a thickness of 11.5 mm. Then, the foamed molded member was sliced into four sliced members, so that the synthetic resin stamp having a thickness of 2.8 mm was obtained for each of the examples No. 1 to No. 3.

In the experiment, the synthetic resin stamps of the examples No. 1 to No. 3 were evaluated using a stamp pad (HGN-2, a black pigment type, a product of Shachihata Inc.). It was noticed that the synthetic resin stamps of the examples No. 1 to No. 3 were looked similar. However, close observation revealed that an appearance of the synthetic resin stamp of the example No. 2 was poor as compared with those of the synthetic resin stamps of the examples No. 1 and No. 3. As a result of the evaluation, it was found that the synthetic resin stamp using the molding material of the example No. 2 showed an inferior result as compared with those using the molding materials of the examples No. 1 and No. 3. Accordingly, the synthetic resin stamps of the examples No. 1 and No. 3 were further evaluated.

In order to evaluate organic solvent resistance of the synthetic resin stamps, a solvent generally used in a stamp pad was selected. A commercially available stamp pad includes a non-absorption face stamp pad (a metal, a plastic, glass, leather, a cloth, and the like).

In the evaluation, the solvent may include a glycol ether type solvent such as ethylene glycol mono-methyl ether, ethylene glycol mono-ethyl ether, and ethylene glycol mono-propyl ether; a diol type solvent such as ethylene glycol, propylene glycol, and 2-methyl 2, 4-pentane dicol; an ester type solvent such as polypropylene glycol monoricirate; and an alcohol type solvent such as methanol, ethanol, isopropyl alcohol (IPA), butanol, 3-methoxy 1-butanol.

In the evaluation, dipropylene glycol mono-methyl ether and 3-methoxy 1-butanol were selected as one of most commercially available solvents. The synthetic resin stamp was immersed in dipropylene glycol mono-methyl ether and 3-methoxy 1-butanol for 30 days. After the immersion, the synthetic resin stamps using the molding materials of the examples No. 1 and No. 3 did not exhibit any problem.

In order to evaluate combustion property of the synthetic resin stamps, the molding materials of the examples No. 1 and No. 3 were burned, and compared with a rubber material. Then, an extent of oil smoke was visually evaluated. As a result of the evaluation, all of the materials generated oil smoke. However, the rubber material generated oil smoke several times more than the molding materials of the examples No. 1 and No. 3.

In general, a rubber material is known to contain sulfur and a nitrogen compound. Accordingly, when the rubber material is burned, sulfuric oxide and nitric oxide are generated, thereby causing strong odor. On the other hand, the molding materials of the examples No. 1 and No. 3 do not contain sulfur and a nitrogen compound. Accordingly, when the molding materials of the examples No. 1 and No. 3 are burned, sulfuric oxide and nitric oxide are not generated, thereby causing little odor.

In order to evaluate storage property of the synthetic resin stamps, the molding materials of the examples No. 1 and No. 3 were placed under a room temperature for six months. Afterward, the molding materials of the examples No. 1 and No. 3 were placed in the resin molding die, and were cross-linked at 160° C. for six minutes with the direct pressure molding machine. As a result, it was possible to obtain a molded part with good quality. In general, it is necessary to store a rubber material under a refrigerated condition. On the other hand, in the embodiment, it is possible to store the molding materials of the examples No. 1 and No. 3 under a room temperature.

In order to evaluate engraving property of the synthetic resin stamp, the molding material of the example No. 1 was placed in an aluminum molding die having a thickness of 3 mm and a size of 100 mm square. Then, the molding material of the example No. 1 was pressed and molded at 170° C. for six minutes. Then, a molded part was engraved with a laser. As a result, it was possible to obtain an engraved part with good quality.

The disclosure of Japanese Patent Application No. 2015-175553, filed on Sep. 7, 2015 is incorporated in the application by reference.

While the invention has been explained with reference to the specific embodiments of the invention, the explanation is illustrative and the invention is limited only by the appended claims.

What is claimed is:

1. A method of producing a synthetic resin stamp, comprising the steps of:
mixing 35 to 45 weight % of a polyethylene resin, 11 to 22 weight % of a thermoplastic elastomer, 35 to 45 weight % of a filling material, 2 to 7 weight % of a cross-linking agent, and 2 to 7 weight % of a foaming agent to obtain a molding material;
placing the molding material in a molding die;
performing a direct pressure molding at 160° C. to 190° C. for 3 to 10 minutes for performing a cross-linking reaction and a foaming reaction to obtain a foamed molded member formed of foam cells;
slicing the foamed molded member to obtain a sliced member; and
performing a laser engraving process on a surface of the sliced member to obtain the synthetic resin stamp.

2. The method of producing the synthetic resin stamp according to claim 1, wherein, in the step of mixing the polyethylene resin, the thermoplastic elastomer, the filling material, the cross-linking agent, and the foaming agent, said filling material is an inorganic compound.

3. The method of producing the synthetic resin stamp according to claim 1, wherein, in the step of mixing the polyethylene resin, the thermoplastic elastomer, the filling material, the cross-linking agent, and the foaming agent, said filling material is talc.
